(19) United States
(12) Patent Application Publication
(10) Pub. No.: US 2012/0035991 A1
(43) Pub. Date: Feb. 9, 2012

(54) BEVERAGE CONTAINER CROSS-PROMOTION

(75) Inventor: Mark FIORITO, Sonoma, CA (US)

(73) Assignee: Pull it Sir Spirits Co., Sonoma, CA (US)

(21) Appl. No.: 13/175,719

(22) Filed: Jul. 1, 2011

Related U.S. Application Data
(60) Provisional application No. 61/371,761, filed on Aug. 9, 2010.

(51) Int. Cl. G06Q 30/00; B65D 25/00

(52) U.S. Cl. 705/14.1; 220/694

(57) ABSTRACT

A beverage container may include a promotional token that can be redeemed for credit at a gambling facility. The token may need to be authenticated to prevent fraud. Redemption of the token may include an exchange of personal information or may require a purchase of a service and/or good, e.g. from a gambling facility, or a commitment to make such a purchase.

### RELATED APPLICATIONS

This application is related to U.S. Provisional Patent Application Ser. No. 61/371,761, entitled “Beverage Container and Method For Marketing Same,” and filed Aug. 9, 2010. All of the related applications are hereby incorporated by reference into the present application in their entirety.

### FIELD OF THE INVENTION

The invention relates to methods and systems for providing cross-promotional marketing, using one type of product, such as a beverage container, to promote another type of product, such as patronage of a gambling facility. In particular the invention relates to a beverage container that removably retains a promotional token that may be used in the promotion and/or marketing of commercial goods and/or services.

### BACKGROUND OF THE INVENTION

The combination of promotional material and a consumer good is known. For example, promotional material may be concealed under the pull tab of a can, such that it is revealed by opening the can. Synergistic benefits of cross-promotion are known to marketing professionals.

### SUMMARY

One aspect of the invention relates to a beverage container for an alcoholic beverage, such as a bottle. The beverage container may be configured to removably retain a token, such as a promotional token. The promotional token may have the shape and/or appearance of a casino chip, a medallion, a coin, and/or another physical object that is detachable from the beverage container. The promotional token may be redeemable by a customer (herein referred to as a “user”) for credit at one or more gambling facilities and/or businesses affiliated with one or more gambling facilities. Redemption of the promotional token by the user may be conditional to an exchange. For example, the user may agree to share personal information of the user, or commit to purchase a service and/or good, e.g. from a gambling facility, in return for redemption of the promotional token.

One aspect of the invention relates to a system for providing cross-promotional marketing. The system may include a “promotional server”. The promotional server may include (access to) electronic storage, an electronic connection to one or more servers and/or computer networks, one or more executable computer program modules, and/or other components. The electronic connection may provide access to private networks, public networks, networks that are partially private and partially public, networks for which parts alternate between being private and public, and/or other networks including any combination of heretofore-mentioned networks or the Internet. Interaction with the promotional server may be performed through one or more client computing platforms, which may provide access to one or more of the afore-mentioned networks. The promotional server may include executable computer program modules for managing user accounts and user access. The promotional server may authenticate and redeem promotional tokens, e.g. via executable computer program modules. Note that the functionality performed by or attributed to the promotional server may be provided by a plurality of servers and/or entities. The entities administering and/or controlling the server(s) performing the recited functions may include one or more of an alcohol vendor/distributor, an alcohol retailer, a casino, and/or other entities.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a front elevation view of a beverage container configured in accordance with the disclosure herein.

FIG. 2 illustrates a side elevation view of a beverage container configured in accordance with the disclosure herein.

FIG. 3 illustrates a system configured to provide cross-promotional marketing.

FIG. 4 illustrates a method to provide cross-promotional marketing.

### DETAILED DESCRIPTION

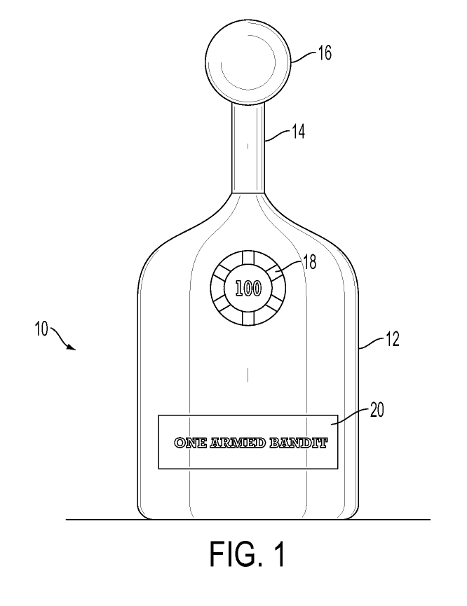

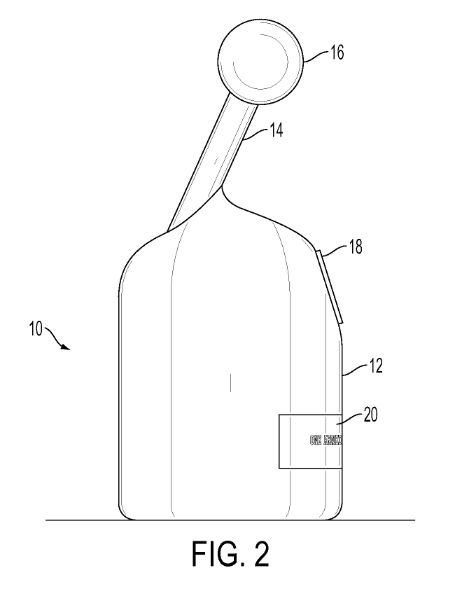

FIG. 1 illustrates a front elevation view of a beverage container 10 configured in accordance with the disclosure herein. Beverage container 10 may be a bottle, a can, a keg, and/or another beverage container. Beverage container 10 may contain an alcoholic beverage, including beer, wine, rum, vodka, whiskey, tequila, and/or other alcoholic beverages. In some implementations, the shape of beverage container 10 may be similar to the shape of a slot machine or “one-armed bandit,” as shown, e.g., in FIG. 1 and FIG. 2. Beverage container 10 may include a bottle body 12, a neck 14, a screw top 16, a token 18, a label 20, and/or other components.

Beverage container 10 may be configured to removably retain token 18, such as a promotional token. Token 18 may have the shape and/or appearance of a casino chip, a medallion, a coin, and/or another physical object that is detachable from the beverage container. Token 18 may be attached to beverage container 10 in a prominently visible location. Token 18 may be attached in a manner so that it may be intentionally removed by the purchaser after purchase. For example, token 18 may be affixed to beverage container 10 with adhesive, or placed beneath a transparent seal, or in any other manner consistent with being removably retained by beverage container 10. Label 20 may include product identifying information and/or regulatory (required) information, and/or instructions for registration and redemption of token 18.

Token 18 may be redeemable by a customer and/or purchaser (herein referred to as a “user”) for credit at one or more gambling facilities. The one or more gambling facilities may include one or more casinos, hotels, and/or other business affiliated and/or associated with one or more casinos and/or hotels. Redemption of token 18 by the user may be conditional to an exchange. For example, the user may agree to share personal information of the user, or commit to purchase a service and/or good, e.g. from a gambling facility, in return for redemption of token 18.

The process of redeeming token 18 may include the steps of obtaining authorization to access a user-specific user account, obtaining a token identifier of token 18, authenticating the token based on the token identifier, increasing an amount of credit associated with the user account by the amount of credit included in the token, exchanging, in return for the redemption, one or both of an agreement to share personal information of the user, and/or a commitment by the user to purchase a service and/or good from one or more gambling facilities (or a business associated therewith), and/or other steps. These steps may be performed by and/or in conjunction with a promotional server. The personal information may include the user's name, address, email address, financial information, purchasing habits, purchasing history, demographic information, answers to a survey, and/or other personal information. In some implementations, the commitment may pertain to a voucher redeemable for a future service, such as a future stay at a hotel.

The token identifier of token 18 may be conveyed by a marker that is carried by token 18. The marker may include a machine-readable marker, including one or more of an RF tag, a barcode, a QR code, and/or another machine-readable marker. Alternatively, and/or simultaneously, the marker may include concealed information, including one or more of a scratch-off code, a magnetic strip, an authorization code, and/or other concealed information. A user may use a client computing device, e.g. a smartphone such as an iPhone®, to process the marker. For example, the user may use an iPhone® application to “read” and/or process the (machine-readable) marker and connect, on behalf of the user, to a promotional server to redeem token 18. The application may obtain the marker and/or the concealed information, once revealed, e.g. through a captured image on the smart phone and/or through manual entry by the user, and transmit the formerly concealed information to a promotional server to redeem token 18.

FIG. 2 illustrates a side elevation view of beverage container 10 configured in accordance with the disclosure herein. As illustrated by the angle of neck 14, beverage container 10 may intentionally be shaped to resemble the shape of a slot machine or “one-armed bandit”.

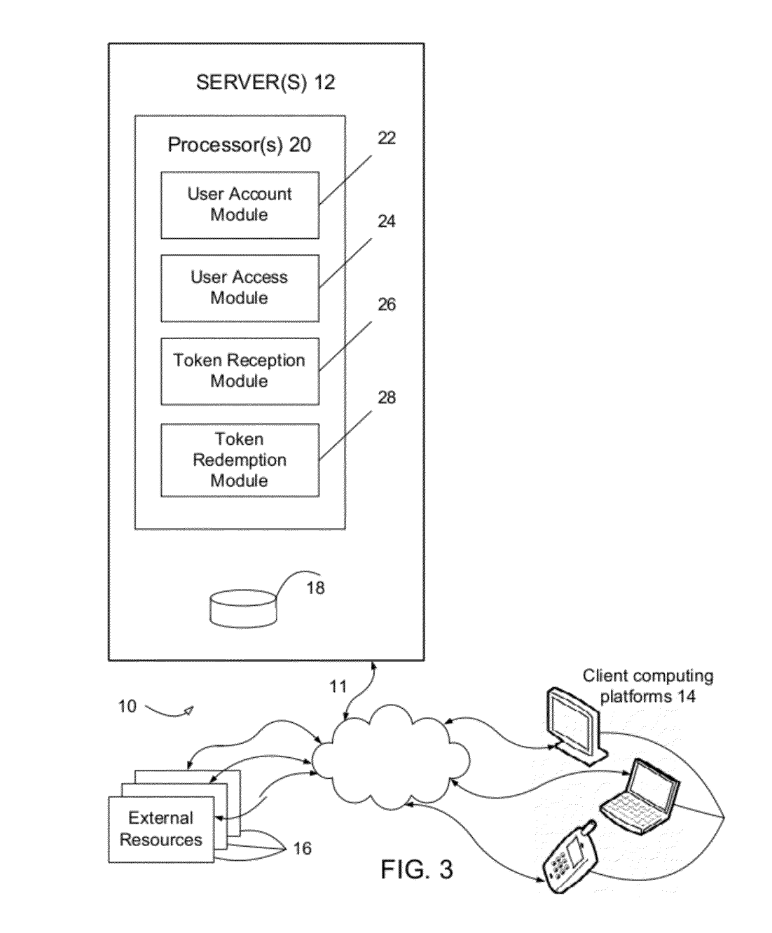

FIG. 3 illustrates a system 10 configured to provide cross-promotional marketing. System 10 may include one or more promotional server(s) 12, one or more external resource(s) 16, one or more client computing platform(s) 14, and/or other components.

External resources 16 may include sources of information, servers, hosts and/or providers of virtual environments, external entities participating with system 10, external vendors, and/or other resources. In some implementations, some or all of the functionality attributed herein to external resources 16 may be provided by resources included in system 10.

Client computing platform(s) 14 may include one or more processors configured to execute computer program modules. The computer program modules may be configured to enable an expert or user associated with a given client computing platform 14 to interact with system 10, external resources 16, and/or provide other functionality attributed herein to client computing platforms 14. By way of non-limiting example, the given client computing platform 14 may include one or more of a desktop computer, a laptop computer, a handheld computer, a NetBook, a Smartphone, a tablet, a gaming console, and/or other computing platforms.

Promotional server 12 may include (access to) electronic storage 18, an electronic connection 11 to one or more servers and/or computer networks, one or more processor(s) 20, and/or other components. Note that the functionality of the promotional server, including any actions attributed to the promotional server, may be provided by a plurality of servers and/or entities. Promotional server 12 may be configured to communicate with client computing platforms 14 according to a client/server architecture. The users may access system 10 via client computing platforms 14.

It will be appreciated that discussion herein of “the connection” between promotional server 12 and client computing platform 14 is not limited to a single communication pathway, protocol, or set of protocols. For example, “the connection” may refer to an RF communication connection (e.g., CDMA, 3G, and/or other RF communication connections) and/or a WiFi connection that may be used alternatively to each other by the same client computing platform 14 and promotional server 12 to communicate.

Electronic storage 18 of promotional server 12 may comprise electronic storage media that electronically stores information. The electronic storage media of electronic storage 18 may include one or both of system storage that is provided integrally (i.e., substantially non-removable) with promotional server 12 and/or removable storage that is removably connectable to promotional server 12 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 18 may include one or more virtual storage resources (e.g., cloud storage, a virtual private network, and/or other virtual storage resources). Electronic storage 18 may store software algorithms, information determined by processor 20, and/or other information.

Processor(s) 20 may be configured to provide information processing capabilities in system 10 and/or promotional server 12. As such, processor 20 may include one or more of a digital processor, an analog processor, a digital circuit designed to process information, an analog circuit designed to process information, a state machine, and/or other mechanisms for electronically processing information. Although processor 20 is shown in FIG. 3 as a single entity, this is for illustrative purposes only. In some implementations, processor 20 may include a plurality of processing units. These processing units may be physically located within the same device, or processor 20 may represent processing functionality of a plurality of devices operating in coordination.

Processor(s) 20 may be configured to execute one or more executable computer program modules, including a user account module 22, a user access module 24, a token reception module 26, a token redemption module 28, and/or other modules. Processor(s) 20 may be configured to execute modules via software, hardware, firmware, some combination thereof, and/or through other processor configuration mechanisms.

It should be appreciated that although modules 22, 24, 26, and 28 are illustrated in FIG. 3 as being co-located within a single processing unit, in implementations in which processor 20 includes multiple processing units, one or more of modules 22, 24, 26, and/or 28 may be located remotely from the other modules. The description of the functionality provided by the different modules 22, 24, 26, and/or 28 described below is for illustrative purposes, and is not intended to be limiting, as any of modules 22, 24, 26, and/or 28 may provide more or less functionality than is described. For example, one or more of modules 22, 24, 26, and/or 28 may be eliminated, and some or all of their functionality may be provided by other ones of modules 22, 24, 26, and/or 28. As another example, processor 20 may be configured to execute one or more additional modules that may perform some or all of the functionality attributed below to one of modules 22, 24, 26, and/or 28. In some implementations, one or more functionalities attributed herein to promotional server(s) 12 and/or any of its constituent components may be provided by one or more of the client computing platforms 14. Promotional server(s) 12 may be implemented by a cloud of computing platforms operating together.

User account module 22 may be configured to manage (storage for and/or access to) user accounts, account information, and/or a user profile of a user. User accounts may be user-specific. User accounts may correspond to one user, or more users. User account module 22 may be configured to provide account registration of new user accounts. User account module 22 may be configured to generate a user interface for presentation to users through which entry and/or selection of the required registration information may be received. This user interface may be presented to the users, for example, through client computing platforms 14.

Account information and/or a user profile related to a user account may include information stored by promotional server 12, information stored by one or more client computing platforms 14, information stored by one or more of external resources 16, and/or other storage locations. Account information for a specific user may be included within a user profile associated with the specific user. Account information may include information identifying a user (e.g. a name, a username or handle, a number, an identifier, and/or other identifying information), user information, address information, subscription information, (virtual) currency information (e.g., related to currency held in credit for a user, such as an amount of credit at one or more gambling facilities), relationship information (e.g. regarding other users that are in some way related), usage information, demographic information, settings, preferences, customizations, information related to past interactions, achievements, evaluations, purchases pertaining to a user, information derived by analysis, provided information of a user, stated information, account history of a user, browsing history of a user, a client computing platform identification associated with a user, a phone number associated with a user, and/or other account information.

User access module 24 in FIG. 3 may be configured to manage user access to promotional server 12, and/or to account information and/or a user profile of a user. User access may comprise receipt of an account access authorization. Access to promotional server 12 may be granted pursuant to setup and/or registration of a user account for system 10, such as described above in relation to the operation of user account module 22. Access to system 10 may require one or more of a user account, a user name and/or user identifier, security login information (e.g. an access code and/or password), and/or other information. Other functionalities attributed herein to modules of promotional server 12 may be unavailable to a user until access to system 10 has been authorized through user access module 24. User access module 24 may be configured to generate a user interface for presentation to users through which entry and/or selection of the required authentication information may be received. This user interface may be presented to the users, for example, through client computing platforms 14.

Token reception module 26 in FIG. 3 may be configured to receive and/or obtain a token identifier of token 18. The token identifier may authenticate token 18. Authentication may include a way to distinguish real, valid, and/or as-of-yet unredeemed tokens from counterfeit tokens. Authentication may be required to prevent fraud. The token identifier may be conveyed by a marker carried by the token, as described previously in relation to FIG. 1. Token 18 may have a token value that includes an amount of credit at one or more gambling facilities once redeemed. Token reception module 26 may be configured to generate a user interface for presentation to users through which entry and/or selection of the token identifier information may be received. This user interface may be presented to the users, for example, through client computing platforms 14.

Token redemption module 28 in FIG. 3 may be configured to redeem token 18. Operation of token redemption module 28 may be responsive to one or both of receipt of the account access authorization, and/or authentication of the token based on the token identifier, e.g. by user access module 24 and token reception module 26, respectively. Redemption of token 18 on behalf of a user may include increasing the amount of credit associated with the user's user account by the amount of credit included in the token value of token 18. Alternatively, and/or simultaneously, redemption of token 18 may include presenting the user with the amount of credit included in the token value of token 18 in another way, e.g. by personally handing the user a pre-loaded and/or pre-paid credit and/or debit card. Redemption of token 18 may occur in exchange for one or more of an agreement by the user to share personal information of the user, or a commitment by the user. This commitment may comprise a purchase by the user of a service and/or good from one or more gambling facilities. This purchase may pertain a hotel stay, a voucher redeemable for a future service, and/or another service and/or good from one or more gambling facilities and/or businesses affiliated with one or more gambling facilities. Affiliated businesses and/or entities may include an alcohol vendor/distributor, an alcohol retailer, and/or other entities. The personal information may include a name and/or an email address of the user. The agreement to share personal information may include an agreement to add the user to a mailing list and/or an emailing list, either of which may be used for promotional activities directed to the user.

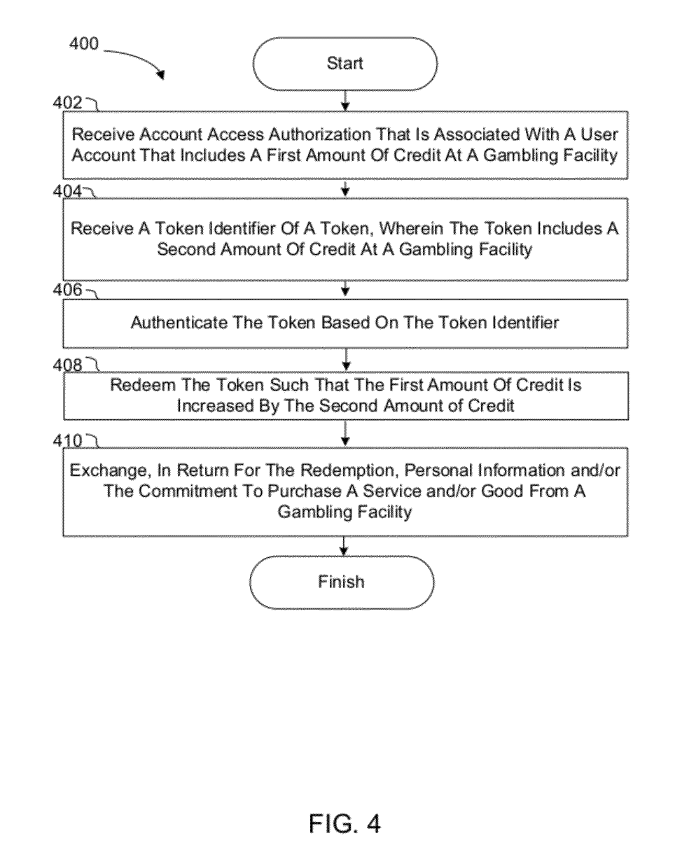

FIG. 4 illustrates a method 400 of providing cross-promotional marketing. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, account access authorization is received that is associated with a user account that includes a first amount of credit at a gambling facility. In some implementations, operation 402 may be performed by a user access module similar to or the same as user access module 24 (shown in FIG. 3 and described herein).

At an operation 404, a token identifier of a token is received, wherein the token includes a second mount of credit at a gambling facility. In some implementations, operation 404 may be performed by a token reception module similar to or the same as token reception module 26 (shown in FIG. 3 and described herein).

At an operation 406, the token is authenticated based on the token identifier. In some implementations, operation 406 may be performed by a token reception module similar to or the same as token reception module 26 (shown in FIG. 3 and described herein).

At an operation 408, the token is redeemed such that the first amount of credit is increased by the second amount of credit. In some implementations, operation 408 may be performed by a token redemption module similar to or the same as token redemption module 28 (shown in FIG. 3 and described herein).

At an operation 410, personal information and/or a commitment is exchanged in return for the redemption of the token. The commitment may be to purchase a service and/or good from a gambling facility. In some implementations, operation 410 may be performed by a token redemption module similar to or the same as token redemption module 28 (shown in FIG. 3 and described herein).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A beverage container configured to provide cross-promotional marketing, the system comprising:
a beverage container for an alcoholic beverage, wherein the beverage container is configured to removably retain a token; and
a token in the shape of a casino chip, wherein the token is configured to be removably retained by the beverage container, wherein the token includes a token identifier that authenticates the token, wherein the token is redeemable for credit at one or more gambling facilities in exchange for one or more of an agreement to share personal information of the user, or a commitment by the user.

2. The system of claim 1, wherein the token identifier is conveyed by a marker carried by the token.

3. The system of claim 2, wherein the marker includes one or more of an RF tag, a barcode, or a QR code.

4. The system of claim 2, wherein the marker includes one or more of a scratch-off code, a magnetic strip, or an authorization code.

5. The system of claim 1, wherein the beverage container is a bottle.

6. The system of claim 1, wherein redemption of the token requires exchange of the commitment by the user, and wherein the commitment comprises a purchase by the user of a service and/or good from the one or more gambling facilities.

7. The system of claim 6, wherein the purchase pertains to a hotel stay.

8. The system of claim 6, wherein the purchase pertains to a voucher redeemable for a future service.

9. The system of claim 1, wherein redemption of the token requires exchange of the agreement to share personal information of the user, and wherein the personal information includes a name and/or an email address of the user.

10. The system of claim 9, wherein the agreement to share personal information further includes an agreement to add the user to one or both of a mailing list and/or an emailing list.

11. A system for providing cross-promotional marketing, the system comprising:
one or more processors configured to execute computer program modules, the computer program modules comprising:
a user account module configured to manage user accounts, wherein the user account module is configured to provide registration of a user account such that the user account corresponds to a user, and wherein the user account includes a first amount of credit at one or more gambling facilities;
a user access module configured to manage user access to the system, wherein user access comprises receipt of an account access authorization, wherein the account access authorization is user-specific, and wherein the account access authorization is associated with the user account;
a token reception module configured to receive a token identifier of a token, wherein the token identifier authenticates the token, wherein the token has a token value, and wherein the token value includes a second amount of credit at one or more gambling facilities; and
a token redemption module configured to, responsive to the receipt of the account access authorization and responsive to authentication of the token, redeem the token, wherein redemption of the token comprises increasing the first amount of credit by the second amount of credit in exchange for one or more of an agreement to share personal information of the user, or a commitment by the user, and wherein redemption of the token further comprises decreasing the token value by the second amount of credit.

12. The system of claim 11, wherein the token has a shape of a casino chip.

13. The system of claim 11, wherein the token is configured to be removably retained by a beverage container.

14. The system of claim 11, wherein the token identifier is conveyed by a marker carried by the token.

15. The system of claim 14, wherein the marker includes one or more of an RF tag, a barcode, a QR code, or an authorization code.

16. The system of claim 14, wherein the marker includes one or more of a scratch-off code, or a magnetic strip.

17. The system of claim 11, wherein redemption of the token requires exchange of the commitment by the user, and wherein the commitment comprises a purchase by the user of a service and/or good from the one or more gambling facilities.

18. The system of claim 17, wherein the purchase pertains to a hotel stay.

19. The system of claim 17, wherein the purchase pertains to a voucher redeemable for a future service.

20. The system of claim 11, wherein redemption of the token requires exchange of the agreement to share personal information of the user, and wherein the personal information includes a name and an email address of the user.

21. The system of claim 20, wherein the agreement to share personal information further includes an agreement to add the user to one or both of a mailing list and/or an emailing list.

22. A method for providing cross-promotional marketing, the method comprising:
receiving account access authorization, wherein the account access authorization is user-specific, and wherein the account access authorization is associated with a user account that includes a first amount of credit at one or more gambling facilities;
receiving a token identifier of a token, wherein the token has a token value that includes a second amount of credit at one or more gambling facilities;
authenticating the token based on the token identifier;
redeeming, responsive to receipt of the account access authorization and authentication of the token, the token such that:
the first amount of credit is increased by the second amount of credit; and
the token value is decreased by the second amount of credit; and
exchanging, in return for the redemption, one or more of an agreement to share personal information of the user, or a commitment by the user, wherein the commitment comprises a purchase by the user of a service and/or good from one or more gambling facilities, and wherein the personal information includes a name and an email address of the user.
